(19) United States
(12) Patent Application Publication
(10) Pub. No.: US 2003/0009698 A1
(43) Pub. Date: Jan. 9, 2003

(54) Spam avenger

(75) Inventors: Terrence Edward Lindeman, Sammamish, WA (US); John Rumpelein, Snohomish, WA (US)

Correspondence Address: MERCHANT & GOULD PC, P.O. BOX 2903, MINNEAPOLIS, MN, 55402-0903, US

(73) Assignee: CascadeZone, Inc., Sammamish, WA (US)

(21) Appl. No.: 10/159,962

(22) Filed: May 29, 2002

Related U.S. Application Data
(60) Provisional application No. 60/294,718, filed on May 30, 2001.

(51) Int. Cl. G06F 11/30; G06F 15/173

(52) U.S. Cl. 713/201; 709/224

(57) ABSTRACT

A method and system for filtering spam is disclosed. The present invention is directed at filtering spam. Generally, whenever a message is first received from an unapproved sender, a confirmation request email is sent to the sender's email address requesting the sender to confirm its existence and identity. Spammers typically don't receive, and can't handle reply emails. Therefore, until the unapproved sender replies to the confirmation request email, electronic messages received by the unapproved sender are treated as spam. An inclusion list of senders is maintained by the spam filter that includes a list of approved senders. Electronic messages from approved senders are not treated as spam, and are immediately delivered to the user. Generally, a database of valid source addresses for a user is maintained either on the user's computing device or on a mail server, depending upon the specific application.

### RELATED APPLICATION

This application claims the benefit of U.S. Provisional Application No. 60/294,718, filed May 30, 2001, the benefit of the earlier filing date of which is hereby claimed under 35 U.S.C. § 119 (e).

### FIELD OF THE INVENTION

This application relates generally to messages received over a network, and, more specifically, to filtering spam.

### BACKGROUND

Almost any user who has participated in a newsgroup, put their email address on a web site, requested any kind of information on the web, made a purchase on the web or handed out a business card to the wrong person, is probably receiving unsolicited Advertising emails (spam) right now. Over time, almost any user's name will be published on CDs and sold to anyone and everyone willing to pay the low cost to obtain the information. Many purchasers use this information to spam users.

Spam CD publishers purchase a spam CD and sell copies of it as their own product. A user's email address will end up on more and more CD's and the users will receive more and more spam over time.

The cost of sending out millions of spam emails is very low. As a matter of fact, the cost of spam emails is significantly cheaper than postal junk mail. In time, a user's inbox and as well as the entire Internet will be choked with offensive unsolicited emails if steps are not taken to fight spammers.

Laws alone can't stop spam. Making spam even harder to regulate is the fact that lots of spam messages comes from overseas. This is a global problem that will reach mammoth proportions.

A new aspect of spam that is just emerging is causing much consternation to cell phone users. Spams are now appearing on cell phones as text messages. This not only wastes the user's time and irritates him, there may be a fee for text messages. So cell phone users may actually be charged for the spams they receive. In most cases, it is trivial for spammers to determine cell phone email address, which are generally based upon cell phone numbers. When a spammer has figured out the format, he has 10,000 cell phone addresses he can spam.

What is needed is a way to effectively fight back against the spam. Many companies offer ways of filtering spam, but none of these filters are effective. A user probably never receives two spams from the same source address or with the same subject heading. In fact, the source address of a spam probably does not even exist. Spammers typically do not want to receive reply emails and they aren't set up to handle them. They want you to click on a link to a web site or to call a phone number.

Existing filters are cumbersome and ineffective. Current email filtering packages are reactive. After an unwanted email is received, the user must define a pattern to exclude future email from this source. Email can, for instance, be excluded based upon a particular email address or a particular text string in the subject line.

Exclusion rules, however, are not very useful. Spammers seldom use the same from-address twice. A user will probably never receive a second email from the same spammer in any case. Additionally, most spams are sent to a group address rather than to an individual address.

### SUMMARY

A method and system is directed at filtering spain. Generally, messages are only delivered to the user when the sender is an approved sender.

According to one aspect of the invention, whenever a message is initially received from an unapproved sender, a confirmation request email is sent requesting the sender to confirm their identity. Spammers typically don't receive, and can't handle reply emails. Therefore, until the unapproved sender replies to the confirmation request email, electronic messages received by the unapproved sender are treated as spam.

According to another aspect of the invention, an inclusion list of approved senders is maintained by the spam filter. Electronic messages from approved senders are not treated as spam, and are immediately delivered to the user. Generally, a database of valid source addresses for a user is maintained either on the user's computing device or on a mail server, depending upon the specific application.

According to yet another aspect of the invention, a hash value is created based on a recipient address, an originator address, and a secret string to help ensure that reply messages are authentic.

Aspects of the invention may be embodied in software and/or hardware and on a computer-readable medium and/or in a modulated data signal.

These and various other features as well as advantages, which characterize the present invention, will be apparent from a reading of the following detailed description and a review of the associated drawings.

### BRIEF DESCRIPTION OF THE DRAWINGS

FIGS. 1-3 show components of an exemplary environment in which the invention may be practiced;

FIG. 4 shows an overview of the process flow for spam filtering;

FIG. 5 shows an exemplary process flow for handling a message from an unapproved sender;

FIG. 6 shows an exemplary confirmation request message;

FIG. 7 illustrates an exemplary process flow for a new message receipt; and

FIG. 8 illustrates exemplary mail flow logic for server-based versions of the spam filter; in accordance with aspects of the invention.

### DETAILED DESCRIPTION

In the following detailed description of exemplary embodiments of the invention, reference is made to the accompanied drawings, which form a part hereof, and which are shown by way of illustration, specific exemplary embodiments of which the invention may be practiced. These embodiments are described in sufficient detail to enable those skilled in the art to practice the invention, and it is to be understood that other embodiments may be utilized, and other changes may be made, without departing from the spirit or scope of the present invention. The following detailed description is, therefore, not to be taken in a limiting sense, and the scope of the present invention is defined by the appended claims.

Throughout the specification and claims, the following terms take the meanings explicitly associated herein, unless the context clearly dictates otherwise.

The term “blacklist group” is a “to” email group address for which messages are to be sent immediately to the blacklist message Folder.

The term “blacklist sender” is a “from” email address for which messages are to be sent immediately to the Rejected Message Folder. No confirmation request will be sent.

The term “message” is an electronic message. An example of a message is an email, a page, a cell phone text message, or some other electronic message sent to a computing device.

The term “bounced message” is a message from a mail server stating that the confirmation request message was sent to an invalid email address, i.e. the spammer used a non-existent “from” address. Typically, this is what happens in the case of spam. The message confirms that the original message was a spam. The bounced message includes the subject line of the confirmation request in the subject, body, or an attachment, and therefore the original message's CZID.

The term “confirmation message” is the reply to a legitimate message an originator sends in response to a confirmation request message. According to one embodiment of the invention, the confirmation message will include the assigned CZID in the subject line. The CZID is necessary to authenticate the confirmation message.

The term “confirmation request message” is a reply email generated by the spam filter for each potential message that may be spam. The reply email includes the original message preceded by a brief explanation stating that the user utilizes spam filtering and that the sender must reply to become a trusted source. The subject line and the body of the confirmation request include information (a CZID) that can be used to authenticate the originator, and recipient.

The term “CZID” is an MD5 hash of the original sender address, the original destination address, and a secret string. A valid CZID is used to authenticate a message, the source email address, and the destination email address to Spam filter.

The term “MD5” is a one-way hash algorithm that takes any length of data and produces a 128-bit “fingerprint”. See the Internet Engineering Task Force RFC 1321 and RFC 822. MD5 hashes are calculated from source and destination addresses plus secret values to insure the authenticity of confirmation request messages sent from the spam filter. If the hash code is regenerated on the receiving side using the same email address and the same secret value, an identical code will result.

The term “message folders” may be actual folders in the email client or server, directories on hard drives, or tables in a database. According to one embodiment of the invention, the message folder structure is as follows:

Inbox

Spam

Blacklist

Bounced

Confirmed

Pending

Requests

The term “inbox folder” is the email folder to which a user's inbound mail is normally delivered. Pending messages are also moved here after their corresponding confirmation is received.

The term “spam folder” is created inside the Inbox Folder to temporarily house messages being processed or created by Spam filter.

The term “blacklist folder includes messages from a blacklisted sender address or to a blacklisted group address are stored here.

The term “bounced folder” includes bounced messages. When a confirmation request is sent to a mail server and that server determines that the addressee is invalid, a “bounced message” reply is sent. This is usually what happens with confirmation requests, because spam originator addresses are generally invalid. According to one embodiment of the invention, bounced messages are retained in the Bounced Folder for a user-definable period of time, normally 30 days.

The term “confirmed folder” includes confirmation messages and are retained for a user-definable period of time, normally 30 days.

The term “pending folder” stores potential spam messages. For each message stored here, a confirmation request has been sent to the originator's email address. If a confirmation is received and authenticated as originating from the original sender, the message is moved to the Inbox Folder. If no confirmation is received after a waiting period (normally 30 days), the message is deleted.

The term “original message” means the email message initially sent to a user. This may be a legitimate message from a trusted sender, a legitimate message from a new sender, or a spam.

The term “pending message” is any inbound email message from an unknown sender. For each pending message, a confirmation request has been sent, but no response has been received. If a valid confirmation is received from the sender within the expiration period (normally 30 days), the sender is added to the trusted sender list and any messages from him are delivered to the user inbox. If no confirmation is received within a user-defined period, normally 30 days, the pending messages are deleted.

The term “recipient address” is the address to which an inbound email is addressed. A user may have multiple aliases. For instance, info@xyz.com for general information requests to his company.

The term “originator address” typically will be the “Return-path” address of an email message. If no reply-to address is present, the “from” address will be used.

The term “setup information ” includes the user's email addresses, expiration periods for messages in folders, whether to trust email address in the contacts list, and other settings and preferences.

The term “spam” is an unsolicited message, such as an email message from an unknown source. Normally a spam advertises a product or service, but sometimes it is a newsletter to which you did not subscribe.

The term “spam filter database” is a collection of information that allows the Spam filter product to function in a given environment. Depending upon the implementation, portions of the data and /or messages may be stored in XML files, other text files, the email folder system, a hard-drive directory system, or full-fledged databases such as Microsoft SQL Server and the open source MySQL. The types of information stored in the Spam filter database may include: trusted senders; trusted groups; setup information; and message folders.

The term “spoofing” is pretending to be someone else on the Internet. Spam filter's CZID authentication makes it extremely difficult for a spammer mail server to pretend to be a Spam filter trusted client to gain access to a user's inbox.

The term “trusted domain” is a domain from which senders are automatically trusted. A trusted domain is essential a trusted sender address in the format*@xyz.com.

The term “trusted group” is a “to” email address for which you are willing to receive messages regardless of whether the “from[ address is trusted. A group of email addresses with common interests is frequently created on a mail server under an alias, such as BoardOfDirectors@xyz.com, or MeetingNotice@abc.org. Any mail addressed to these aliases is automatically routed to members of the list. A user who wishes to receive mail addressed to a group regardless of the sender can manually add that group address to the trusted mail group list.

The terms “trusted sender” and “approved sender” are source email addresses from which a user is willing to accept messages. Any email originating with these addresses will be passed directly through to the user. A trusted sender could be anyone in your email address directory, someone you manually add to the Spam filter database, or anyone who replies to a confirmation request.

The term “tunnel password” is an optional user-defined word which may be included in email messages to let them through the filtering regardless of their source. This password may be distributed to others or it may be included in an outbound email subject so that the reply will pass through unfiltered.

Referring to the drawings, like numbers indicate like parts throughout the views. Additionally, a reference to the singular includes a reference to the plural unless otherwise stated or is inconsistent with the disclosure herein.

Overview

The present invention is directed at filtering spam. Generally, whenever a message is first received from an unapproved sender, a confirmation request email is sent requesting the sender to confirm their identity. Spammers typically don't receive, and can't handle reply emails. Therefore, until the unapproved sender replies to the confirmation request email, electronic messages received by the unapproved sender are treated as spam. An inclusion list of senders is maintained by the spam filter that includes a list of approved senders. Electronic messages from approved senders are not treated as spam, and are immediately delivered to the user. Generally, a database of valid source addresses for a user is maintained either on the user's computing device or on a mail server, depending upon the specific application.

Illustrative Operating Environment

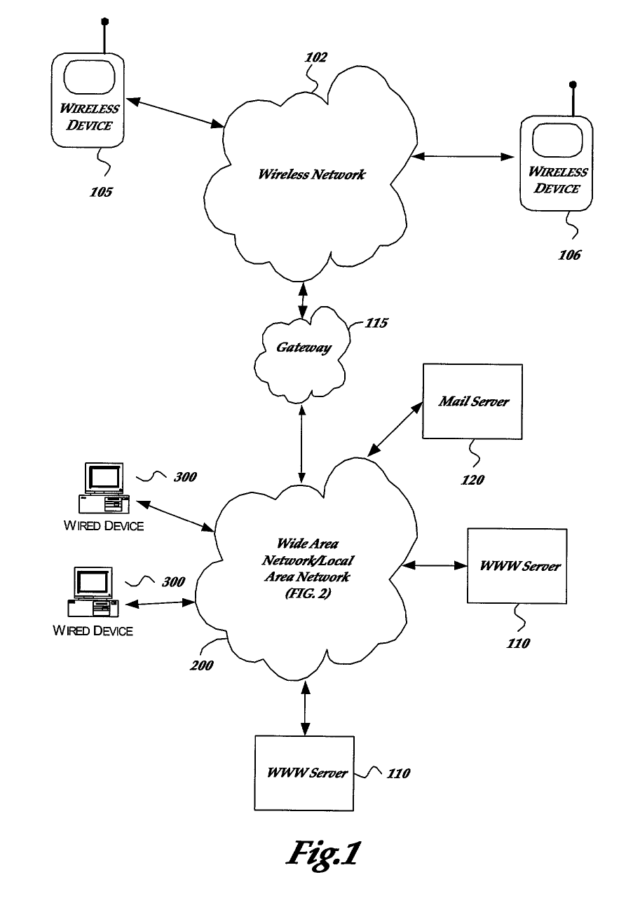

FIGS. 1-3 show components of an exemplary environment in which the invention may be practiced. Not all the components may be required to practice the invention, and variations in the arrangement and type of the components may be made without departing from the spirit or scope of the invention.

Illustrative Operating Environment

With reference to FIG. 1, an exemplary system in which the invention operates includes wireless devices 105-106, wireless network 102, gateway 115, wide area network (WAN)/local area network (LAN) 200, one or more world wide web (WWW) servers 110, one or more mail servers 120 and one or more wired devices 300.

Wireless devices 105-106 are coupled to wireless network 102. Generally, wireless devices 105-106 include any device capable of connecting to a wireless network such as wireless network 102. Such devices include cellular telephones, smart phones, pagers, radio frequency (RF) devices, infrared (IR) devices, citizen band radios (CBs), integrated devices combining one or more of the preceding devices, and the like. Wireless devices 105-106 may also include other devices that have a wireless interface such as PDAs, handheld computers, personal computers, multiprocessor systems, microprocessor-based or programmable consumer electronics, network PCs, wearable computers, and the like.

Wireless network 102 transports information to and from devices capable of wireless communication. Wireless network 102 may include both wireless and wired components. For example, wireless network 102 may include a cellular tower that is linked to a wired telephone network. Typically, the cellular tower carries communication to and from cell phones, pagers, and other wireless devices, and the wired telephone network carries communication to regular phones, long-distance communication links, and the like.

Wireless network 102 is coupled to WAN/LAN through gateway 115. Gateway 115 routes information between wireless network 102 and WAN/LAN 200. For example, a user using a wireless device may browse the Internet by calling a certain number or tuning to a particular frequency. Upon receipt of the number, wireless network 102 is configured to pass information between the wireless device and gateway 115. Gateway 115 may translate requests for web pages from wireless devices to hypertext transfer protocol (HTTP) messages, which may then be sent to WAN/LAN 200. Gateway 115 may then translate responses to such messages into a form compatible with the requesting device. Gateway 115 may also transform other messages sent from wireless devices 105-108 into information suitable for WAN/LAN 200, such as e-mail, audio, voice communication, contact databases, calendars, appointments, and the like.

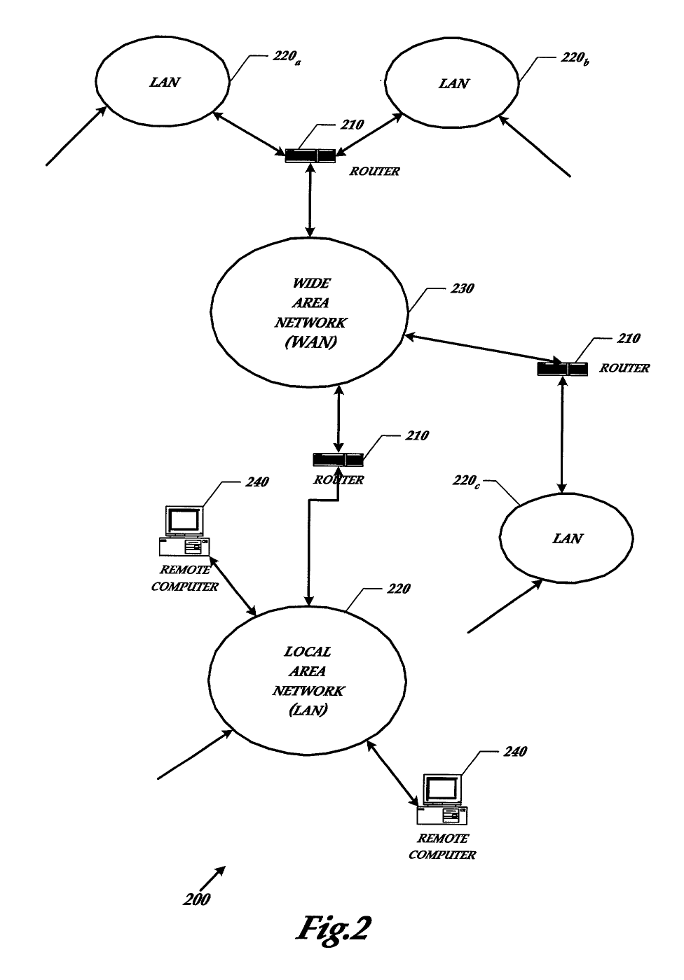

Typically, WAN/LAN 200 transmits information between computing devices as described in more detail in conjunction with FIG. 2. One example of a WAN is the Internet, which connects millions of computers over a host of gateways, routers, switches, hubs, and the like. An example of a LAN is a network used to connect computers in a single office. A WAN may connect multiple LANs.

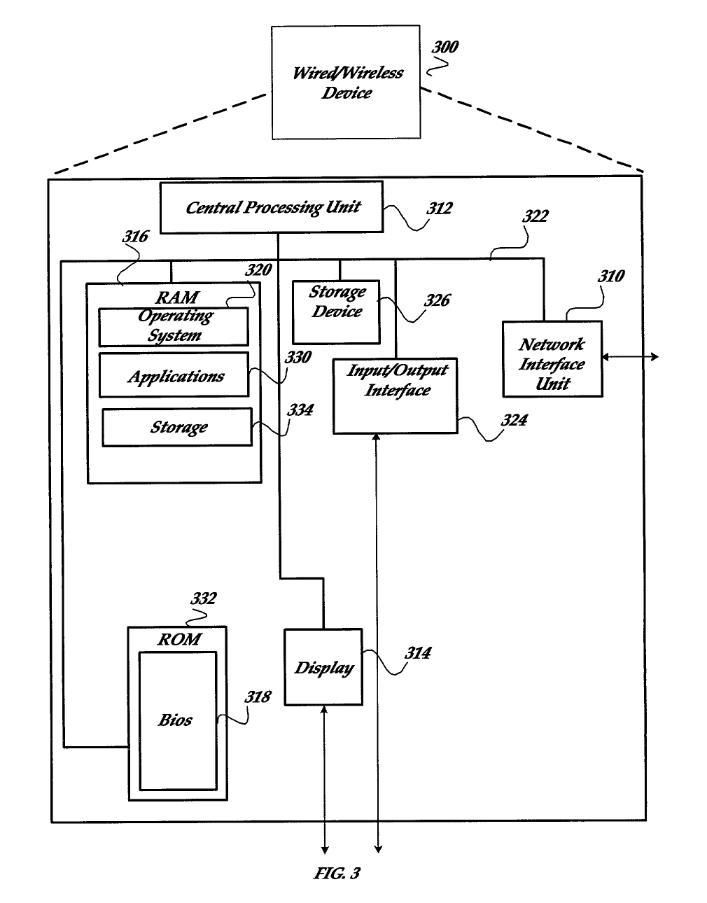

WWW servers 110, mail servers 120, and wired devices 300 are coupled to WAN/LAN 200 through communication mediums. WWW servers 110 provide access to information and services. Wired devices 300 are described in more detail in conjunction with FIG. 3. Mail servers 120 provide email and text messaging capabilities.

FIG. 2 shows another exemplary system in which the invention operates in which a number of local area networks (“LANs”) 220_{a-d} and wide area network (“WAN”) 230 interconnected by routers 210. Routers 210 are intermediary devices on a communications network that expedite message delivery. On a single network linking many computers through a mesh of possible connections, a router receives transmitted messages and forwards them to their correct destinations over available routes. On an interconnected set of LANs—including those based on differing architectures and protocols—, a router acts as a link between LANs, enabling messages to be sent from one to another. Communication links within LANs typically include twisted wire pair, fiber optics, or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links, or other communications links. Furthermore, computers, such as remote computer 240, and other related electronic devices can be remotely connected to either LANs 220_{a-d} or WAN 230 via a modem and temporary telephone link. The number of WANs, LANs, and routers in FIG. 2 may be increased or decreased. The Internet itself may be formed from a vast number of such interconnected networks, computers, and routers and that an embodiment of the invention could be practiced over the Internet.

The media used to transmit information in communication links as described above illustrates one type of computer-readable media, namely communication media. Generally, computer-readable media includes any media that can be accessed by a computing device. Computer-readable media may include computer storage media, communication media, or any combination thereof.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, communication media includes wired media such as twisted pair, coaxial cable, fiber optics, wave guides, and other wired media and wireless media such as acoustic, RF, infrared, and other wireless media.

FIG. 3 shows an exemplary wired/wireless device 300, according to one embodiment of the invention. Device 300 may be arranged to transmit and receive data. For instance, device 300 may send and receive messages from other devices on wired or wireless networks. The data transmissions may take place over the Internet, WAN/LAN 200, or some other communications network.

Device 300 may include many more components than those shown in FIG. 3. However, the components shown are sufficient to disclose an illustrative embodiment for practicing the present invention. As shown in the figure, device 300 includes central processing unit 312, RAM 316, ROM 332, operating system 320, applications 330, storage device 326, bios 318, input/output interface 324, network interface unit 310, and display 314.

Device 300 may connect to wireless network 102, WAN/LAN 200, or some other communications network, via network interface unit 310. Network interface unit 310 includes the necessary circuitry for connecting device 300 to a wired network, a wireless network, or wired and wireless networks, depending on the specific application, and is constructed for use with various communication protocols including the TCP/IP protocol. Network interface unit 310 may include a radio layer (not shown) that is arranged to transmit and receive radio frequency communications.

Memory generally includes RAM 316, ROM 332, and one or more storage devices 334. The mass memory stores operating system 320 for controlling the operation of device 300. This component may comprise a general purpose server operating system, such as a version of UNIX, LINUX™, or Microsoft WINDOWS®. Basic input/output system (“BIOS”) 318 is also provided for controlling the low-level operation of device 300.

The memory also stores program code and data used within device 300. More specifically, the memory stores applications including applications 330. Applications 330 may include computer executable instructions which, when executed by device 300, transmit and receive electronic messages, WWW pages, email, video, and the like. One or more applications 330 may be loaded into memory and run under control of operating system 320. Examples of application programs include communication programs (email and text messaging), productivity programs (word processing, spreadsheet, etc.), browser programs, and the like.

Storage 326 and storage device 334 may be utilized by device 300 to store, among other things, electronic messages that are sent and/or received by the device.

Input/Output interface 324 may be any input/output device arranged to receive inputs or output information. For example, a keypad may be used to receive input from a user. Display 314 may be a liquid crystal display, or any other type of display commonly used in wireless and/or wired devices. Display 314 may also be a touch screen arranged to receive a user's inputs.

As will be recognized from the discussion below, aspects of the invention may be embodied on many different devices, such as servers and devices, such as device 300, or on some combination thereof. For example, programming steps may be contained in programs on the respective devices.

Process Flow

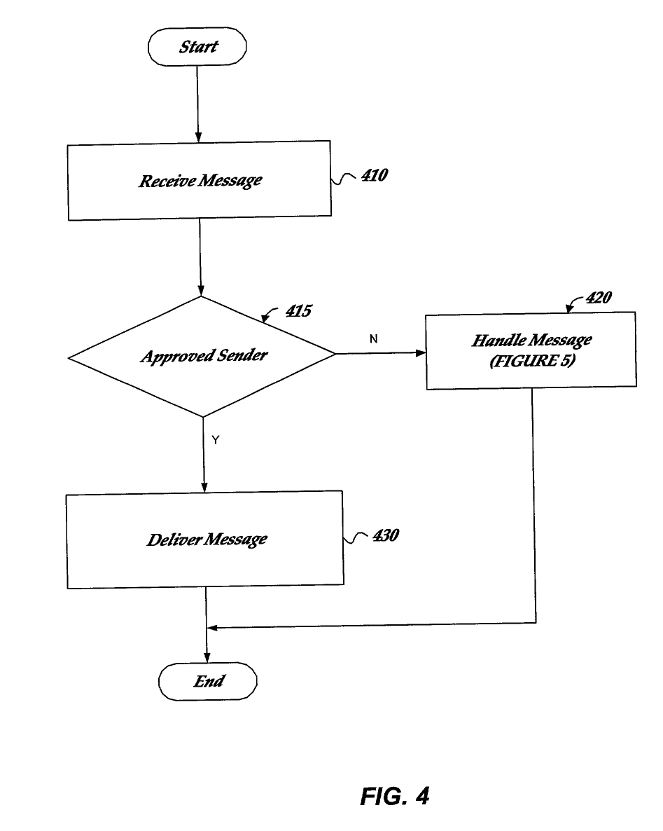

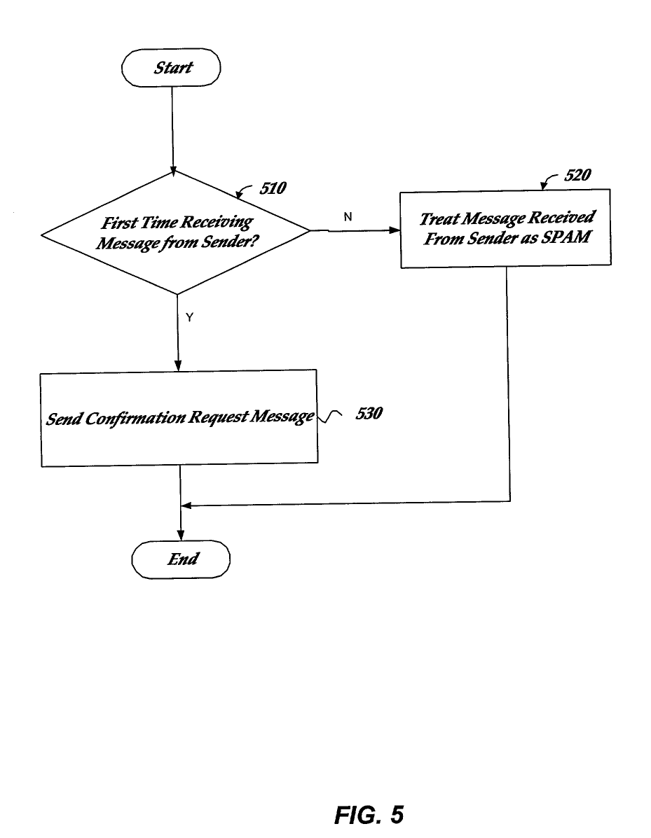

FIG. 4 shows an overview of the process flow for spam filtering, in accordance with aspects of the invention. After a start block, the process moves to block 410 at which point a message is received. The message may be any electronic message, such as an email, a text message, and the like. Moving to decision block 415 a determination is made as to whether the sender is an approved or trusted sender. Generally, an approved sender is a sender who is included in a list of senders from which a user may receive an electronic message. The inclusion list may be manually or automatically populated. Additionally, senders may be approved based on their domain or group, or some other identifying characteristic. For example, messages that include a predetermined string within the subject or message body may be approved. When the sender is not approved, the process flows to block 420, at which point the message is handled (See FIG. 5 and related discussion). Generally, for a first message received by an unapproved sender a confirmation request message is sent to determine if messages received by this sender are spam. When the sender replies to the confirmation request message, the sender becomes a trusted or an approved sender. When the sender is an approved sender, at the process flows to block 430 at which point the message is delivered. The process then flows to an end block and returns to processing other actions.

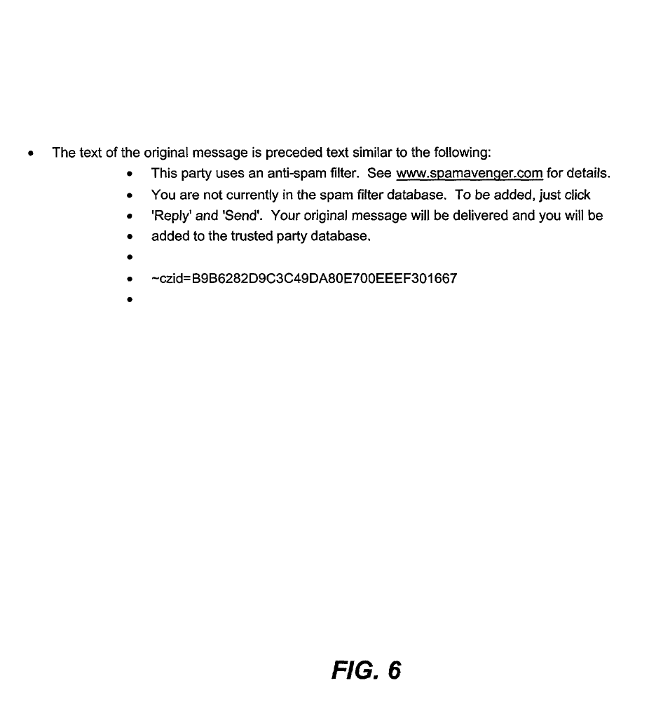

FIG. 5 shows an exemplary process flow for handling a message from an unapproved sender, according to one embodiment of the invention. After a start block, the process moves to decision block 510 where a determination is made as to whether this is the first time a message has been received from the sender. When a message has been received by the sender the process transitions to block 520, where the message received from the sender is treated as spam, and is not delivered to the user. When no prior message has been received from the sender, a confirmation request message is sent to the sender to determine if the sender should be an approved sender (See FIGS. 6-8 and related discussion). According to another embodiment of the invention, a confirmation request message is sent whenever a message is received from an unapproved sender.

FIG. 6 shows an exemplary confirmation request message. As shown in the figure, the message “This party uses an anti-spam filter. See www.spamavenger.com for details. You are not currently in the spam filter database. To be added, just click ‘Reply’ and ‘Send’. Your original message will be delivered and you will be added to the trusted party database” is sent to the sender of the message. Once the sender confirms their identity they will be placed in a trusted database and their messages will not be treated as spam.

The text “˜czid=B9B6282D9C3C49DA80E700EEEF301667” is a hashing code. The use of MD5 hashing to authenticate mail messages provides advantages. By appending a hash code (a CZID) based upon originator email address, recipient email address, and another proprietary character string, the spam filter can ascertain the validity of a message's original source and destination addresses. This eliminates the possibility of spoofing and allows the spam filter to distinguish between several legitimate message types including confirmation requests, confirmations, and server bounces.

With server-based products, the sender of the message will typically be asked to click on a web link instead of replying to the email. A legitimate sender will receive this confirmation email. The sender may reply or click on the link to indicate that the sender is a legitimate sender. The sender will then be added to the database of approved or trusted senders. After this, the approved sender will be able to correspond with the recipient with no further intervention, unless the approved sender is removed from the inclusion list.

As discussed, the present invention is directed at working with electronic messages, such as messages received in the cell phone text-messaging arena as well as in traditional Internet email. Typically, text messages are simply emails stored and forwarded by mail servers and displayed on a cell phone rather than on a traditional computer display.

If an email message is sent from a spammer, i.e. a non-trusted or unapproved sender, the confirmation request message sent back to the spammer's originator address will probably bounce because it's not from a real email address. In the rare case where the spam reply address is legitimate, the spammer's mail server may become choked with reply emails. In addition inbound email limits established for the server may quickly be exceeded. This is because the typical spammer sends emails by the millions. It's virtually impossible to respond to numerous individual emails.

Regardless of whether the confirmation message reaches the spammer's servers, the user is shielded from spam messages from this sender. The user never sees the messages from the spammer, unless the user chooses to examine separate folders containing the messages.

According to one embodiment of the invention, spam filtering is applied on both email clients (desktop computers, laptop computers, palmtop computers, Internet cell phones, and text-messaging phones) and mail servers running Windows, Unix, Linux, or other operating systems. When a client product is used, it is available to the device on which it is installed. When a server product is used, spam filtering is available to any of the users of that mail server. This may include all of the users, or a partial list of the users.

The first message received from any unknown address is typically placed in a pending status. If the message is legitimate, the sender can reply to the confirmation request and gain access to the user.

An inclusion list of valid senders that are allowed access to the user is maintained. Typically, other filtering packages maintain an exclusion list of senders that are not allowed access. The inclusion list may be manually populated or automatically populated.

The spam filtering is sender-driven and automatic. If the sender is not included in the inclusion list, a response is required from the sender before the sender becomes an approved sender and is included in the inclusion database. No action is required of the user who received the message. An advantage of this filter is that it is not recipient-driven. Another advantage is that the spam filtering is automatically performed and not manually performed as compared to other filters. Yet another advantage is that no burden is placed on the spam recipient to implement filter logic.

Exemplary Message Flow

The following section describes an exemplary message and data flow in terms of the Microsoft Outlook Client Version. The logic is similar for client- and server-based versions of the spam filtering.

According to one embodiment of the invention, for Microsoft Outlook on any Microsoft Windows platform, a dynamic link library (dll) is installed on the device to perform the steps described below. According to one embodiment of the invention, the dll is a Component Object Model (COM) add-in for Microsoft Office, and specifically for the Outlook component of Microsoft Office.

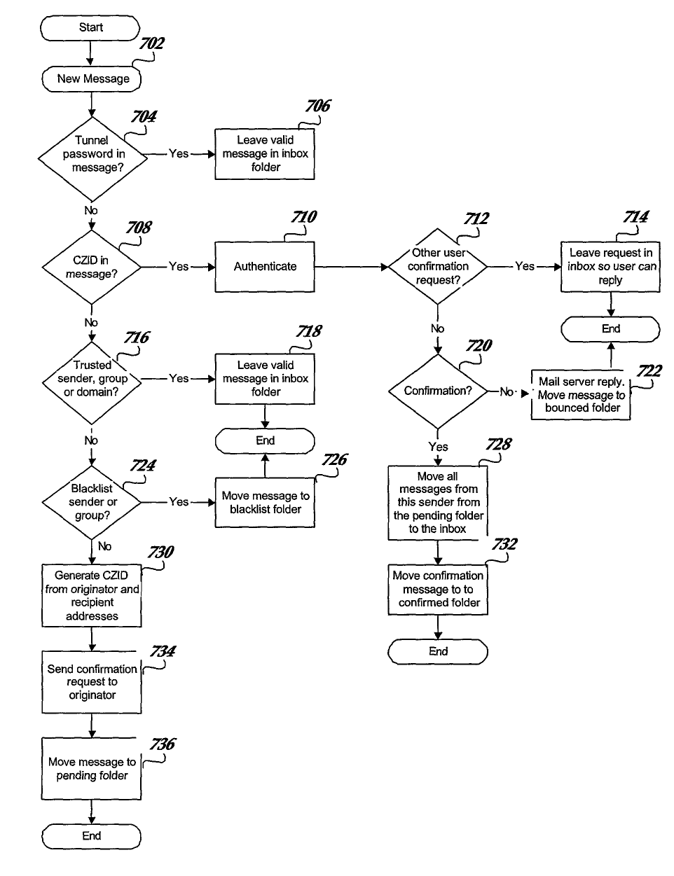

An exemplary process flow for a new message receipt as illustrated in FIG. 7 is as follows. After a start block, the new message is received (block 702). According to one embodiment of the invention, the new email message receipt event is handled by the client's dll.

Flowing to decision block 704, a determination is made as to whether the tunnel password is in the message. According to one embodiment of the invention, the tunnel password is included within the subject of the message. The tunnel password may also be included within the body of the message. When the tunnel password is in the message, the process moves to block 706 where the message is left in the user's inbox and no further processing occurs. In other words, the message is treated as a valid message and not as spam.

Generally, determinations are made as to whether the message subject, body, and attachments display names include the strings “Please confirm:” and “˜czid=abc”. If so, the message was originally generated by the spam filter as a confirmation request message. If the items are not included, the message is potential spam.

When the tunnel password is not in the subject the process moves to decision block 708 where a determination is made as to whether the CZID is in the message. When it is, the CZID is authenticated and the process moves to decision block 712 to determine if the message was created for another spam filter user. If it was, this is a confirmation request from the other user and the process, at block 714, leaves the request in the inbox so that the user may reply. The process then moves to an end block and returns to processing other actions.

If the message did not originate with this email user, this message was generated by a third party mail server to indicate that the confirmation request could not be delivered. In this case, the message is moved to the bounced folder (block 722) and the process moves to an end block and returns to processing other actions.

At this point, CZID authentication has indicated that the user sent this message, a confirmation request, to the other party, and that they replied back to us with a confirmation. The process then moves to block 728 where the originator is added to the trusted sender database, messages from this sender (normally there would only be one) are moved from the pending folder to the inbox (block 728), and the confirmation is moved to the confirmed folder (block 732). The process then moves to an end block and returns to processing other actions.

When the CZID is not in the message, the process flows to block 716 where a determination is made as to whether the sender is a trusted sender. The trusted sender may be a single entity, a group, or a domain. When the message is from a trusted send, the message is left in the inbox folder (block 718) and the process flows to an end block and returns to processing other actions.

When the sender is not trusted, the process flows to decision block 724 where a determination is made as to whether the new email's originator address is in the blacklist senders' list or if the recipient address is in the blacklist group list. If so, the message is moved to the blacklist message folder (block 726) and the process moves to an end block and returns to processing other actions.

When the sender is not blacklisted the process moves to block 730 where a CZID is generated from the originator and recipient email addresses. A confirmation is request is sent to the sender of the message (block 734). According to one embodiment of the invention, the following items are added to the original text of the message to produce the confirmation email. The subject is preceded by “Please Confirm:” The subject of the message is followed by “˜czid=abc . . . ”, where “abc . . . ” is the CZID generated above. A sample subject would be: Please confirm: Let's do lunch!˜czid=B9B6282D9C3C49DA80E700EEEF301667. The message is then moved to a pending message folder (block 736).

Server-Based Spam Filter Logic

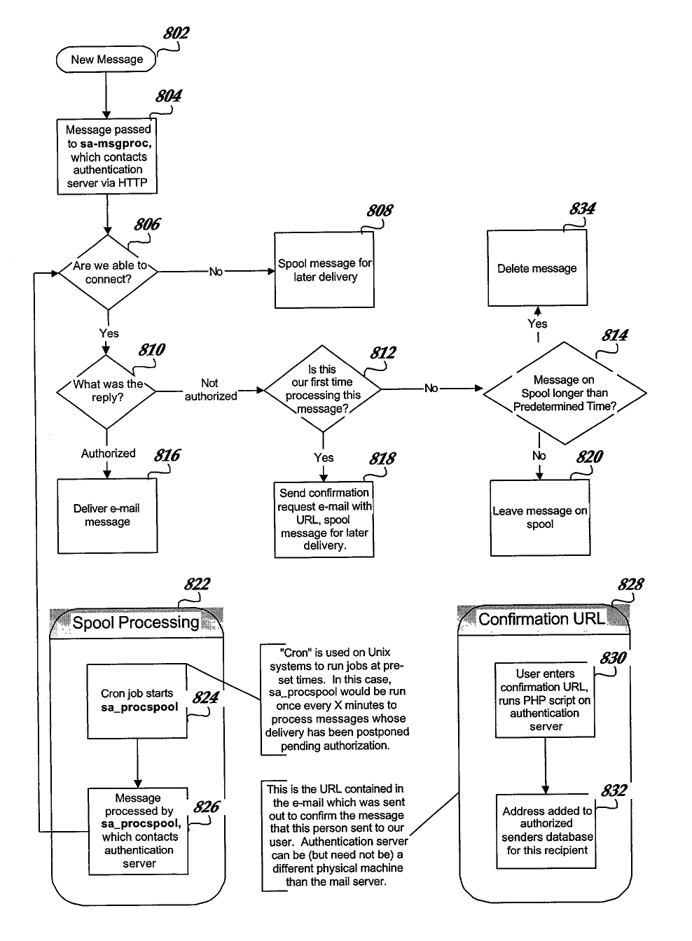

FIG. 8 illustrates exemplary mail flow logic for server-based versions of the spam filter. Although references are specifically for Unix-based email servers, the logic is similar for other mail server products such as Microsoft Exchange.

For a server-based version two components are involved in the processing of incoming messages. The first of these is the mail server receiving the emails, and the second is the authentication server. For simple configurations, these two roles may be filled by the same physical machine.

Upon receipt of a message (block 802), the mail server invokes sa_msgproc, which contacts the authentication server using HTTP (block 804). The use of HTTP allows the spam filter to tunnel through firewalls. Other protocols may be used. At decision block 806 a determination is made as to whether a connection with the authentication server was established. When a connection may not be established, the process flows to block 808 where the message is spooled for later delivery. The authentication server runs a CGI script, which contacts a SQL database containing approved addresses and user-tunable settings, to determine the reply. If the originating address is contained in the database for this recipient, the authentication server approves delivery. In this case, the message is delivered normally (block 816). The logic employed by the authentication server is nearly identical to that described in the client logic above. (Please see FIG. 7 and related discussion.)

If delivery is not approved, a determination at decision block 812 is made as to whether this is the first time processing this message. If so, the message is retained on a pending message spool for later delivery and a confirmation message is generated and sent (block 818). This message contains CZID, a unique ID for this email message, and a URL link for confirming that the sender is an actual human being. The message also contains special headers to identify it as a confirmation email, in case the originator is also using the spam filter.

When the originator receives the confirmation request and clicks on the URL, a CGI script on the authentication server is run. This adds this user to the recipient's authorized senders list contained in the database.

When it is not the first time processing the message, the process moves to decision block 814 where a determination is made as to whether the message has been stored longer than a predetermined time. According to one embodiment of the invention, the predetermined time is one week. When the message has been on the spool longer than the predetermined time, the process moves to block 834 where the message is deleted. Otherwise, the process moves to block 820 where the message is left on the spool.

At regular intervals, the mail server will invoke the sa_procspool program (block 824), which will go through the pending mail messages residing on the system, and check each originator for validity (block 826). This check is performed in the same way as the first time around. If the originator has since been identified as an authorized sender, the original message is delivered. If the originator has not been added to the authorized senders list within a week, the message will be deleted from the system.

Through forms and CGI scripts available to the end user, the authentication server will also allow adjustments to the authorized senders list and other settings. This way the user will be able to allow messages through from an entire company (*@somecorp.com), or temporarily disable processing of messages by the spam filter, so that messages can be passed through directly for testing.

Some companies and organizations may opt to outsource hosting of their authentication server. For instance, a hosting company could host either dedicated or virtual managed database servers for organizations that desire this service. This will reduce the need for on-site IT staff to support the system.

Maintenance Functions

In many instances, the user will accept default parameters and behavior, but he may wish to modify the default behavior of Spam filter, to view the database, or to manually update the database. According to one embodiment of the invention, the Windows Outlook client provides Windows dialogs for these purposes. Server versions of the product typically deliver web-based dialogs through the Internet instead. Regardless of the editing mechanism, the basic editing facilities include the following functions: a trusted sender list maintenance function; a trusted group maintenance function; a setup function; and a view spam folders function.

The Trusted Sender List Maintenance function provides the ability to review, edit, add, and delete trusted senders (“from” addresses). If senders at a domain are trusted, an email address of the form *@domain.com may be entered.

The Trusted Group Maintenance function provides the ability to review, edit, add, and delete trusted groups (“to” addresses).

The setup function allows the user to set Spam filter parameters such as, expiration periods for pending messages, expiration periods for other messages, “Trust addresses in contact list?”, “Add outbound email addresses to trusted list?”, Optional password that may used to allow messages through regardless of trust status.

The View Spam Folders function allows the user at any time to view messages in any of the folders including pending and bounce messages.

The various embodiments of the invention may be implemented as a sequence of computer implemented steps or program modules running on a computing system and/or as interconnected machine logic circuits or circuit modules within the computing system. The implementation is a matter of choice dependent on the performance requirements of the computing system implementing the invention. In light of this disclosure, it will be recognized by one skilled in the art that the functions and operation of the various embodiments disclosed may be implemented in software, in firmware, in special purpose digital logic, or any combination thereof without deviating from the spirit or scope of the present invention.

The above specification, examples and data provide a complete description of the manufacture and use of the composition of the invention. Since many embodiments of the invention can be made without departing from the spirit or scope of the invention, the invention resides in the claims hereinafter appended.

What is claimed is:

1. A method for filtering SPAM, comprising:
receiving a message associated with a sender;
determining when the sender is an approved sender by determining when the sender is included in an inclusion list for a user, and when, delivering the message to the user;
otherwise, handling the message.

2. The method of claim 1, wherein handling the message further comprises
sending a confirmation request message that requests a confirmation message from the sender;
determining if the confirmation message is received from the sender, and if the confirmation message is received, classifying the sender as an approved sender; otherwise classifying the sender as an unapproved sender.

3. The method of claim 2, wherein sending the confirmation request message further comprises creating a hash value based on a recipient address and an originator address.

4. The method of claim 3, wherein creating the hash value is further based on a secret string.

5. The method of claim 2, wherein the inclusion list may be populated both manually and automatically.

6. The method of claim 2, wherein determining if the confirmation message is received from the sender further comprises authenticating the confirmation message.

7. The method of claim 6, wherein authenticating the confirmation message further comprises generating a hash value based on the confirmation message and checking the confirmation message hash value against the hash value within the confirmation message.

8. The method of claim 1, wherein determining when the sender is an approved sender further comprises determining when the sender is included a blacklist, and when determining that the sender is unapproved.

9. A computer readable medium, having computer-executable instructions for filtering spam, comprising:
receiving a message associated with a sender;
checking an inclusion list for the sender;
determining when the sender is an approved sender; and when, delivering the message to the user;
otherwise, handling the message to determine if the message is spam.

10. The computer readable medium of claim 9, further comprising checking a blacklist for the sender, and when the sender is included in the blacklist determining that the sender is unapproved.

11. The computer readable medium of claim 10, wherein handling the message further comprises:
sending a confirmation request message to the sender;
determining if the confirmation message is received from the sender, and if the confirmation message is received:
authenticating the confirmation message;
classifying the sender as an approved sender if the confirmation message is authenticated; otherwise classifying the sender as an unapproved sender.

12. The computer readable medium of claim 11, wherein sending the confirmation request message further comprises creating a hash value based on a recipient address and an originator address and including the hash value within the confirmation request message.

13. The computer readable medium of claim 12, wherein creating the hash value is further based on a secret string.

14. The computer readable medium of claim 11, wherein the inclusion list may be populated manually and automatically.

15. The computer readable medium of claim 15, wherein authenticating the confirmation message further comprises ensuring that the hash value in the confirmation message is authentic.

16. A system for filtering spam, comprising:
a network interface unit arranged to receive a message from a sender on a network;
a storage device for storing data;
an operating system; and
a program configured to perform the following functionality:
checking an inclusion list for the sender;
determining when the sender is an approved sender; and when, delivering the message to the user;
otherwise, handling the message to determine if the message is spam.

17. The system of claim 16, wherein the program further comprises checking a blacklist for the sender, and when the sender is included in the blacklist determining that the sender is unapproved.

18. The system of claim 16, wherein handling the message further comprises:
sending a confirmation request message to the sender;
determining if the confirmation message is received from the sender, and if the confirmation message is received:
authenticating the confirmation message;
classifying the sender as an approved sender if the confirmation message is authenticated; otherwise classifying the sender as an unapproved sender.

19. The system of claim 16, wherein sending the confirmation request message further comprises creating a hash value based on a recipient address, an originator address, and a secret string, and including the hash value within the confirmation request message.

20. A modulated data signal having computer instructions encoded thereon, comprising:
a means for receiving a message associated with a sender;
a means for sending a confirmation request message to an unapproved sender;
a means for determining when the sender is an approved sender; and
a means for delivering the message to a user who is an approved sender.
